(19) United States
(12) Patent Application Publication
(10) Pub. No.: US 2013/0182187 A1
(43) Pub. Date: Jul. 18, 2013

(54) APPARATUS AND SYSTEM FOR CONTROLLING PHOTOMOSAIC OF PROJECTOR WITH DMX PROTOCOL

(71) Applicant: TA-CHE HUANG, Wanchai (HK)

(72) Inventor: TA-CHE HUANG, Wanchai (HK)

(21) Appl. No.: 13/348,650

(22) Filed: Jan. 12, 2012

(51) Int. Cl. H04N 5/44

(52) U.S. Cl. 348/725

(57) ABSTRACT

An apparatus and system for controlling photomosaic of projector with DMX protocol includes a DMX signal receiver processing circuit, an MCU microprocessor circuit, an image processing module, a projection module device, an electromechanical driving circuit, a DMX signal input port, a storage device, and a video input port. The DMX signal receiver processing circuit includes a DMX signal input port. The MCU microprocessor circuit is connected with the image processing module, the projection module device, and the electromechanical driving circuit. The image processing module is connected with a storage device port and the video input port. The image processing module is connected with the projection module device. The system includes standard DMX ports and is compatible to DMX ports of lighting device. Multiple projection devices can be used to simultaneously project images that are joined to form an image of a larger size to thereby realize perfect image mosaic.

### TECHNICAL FIELD OF THE INVENTION

The present invention generally relates to the field of apparatus and system for controlling photomosaic of projector with DMX protocol, which is a technique of using a DMX protocol apparatus and system to control photomosaic of projector, and in particular to an apparatus and system that controls multiple projectors on the basis of DMX protocol to show seam-free photomosaic.

### DESCRIPTION OF THE PRIOR ART

Projectors are widely used in various applications, such as household, commercial, industrial, and theater applications. The image projected by the known projections is generally of a fixed size. To project a large-sized image, photomosaic must be employed for more than one projector. The known projection devices that are currently available in the market rely on computers, such as personal computers, or media servo to carry out image processing operations, such as image joining, edge fusing, image correction, and special effects. The function and operation of these known devices are complicated and expensive.

DMX is an abbreviation standing for Digital Multiplexer, which is commonly adopted and followed by worldwide stage lighting fixture manufacturers and is now a commonly used digital lighting control protocol. In other words, each controlled lighting unit can be digitalized provided it complies with this protocol.

DMX-152 or DMX-512A provides a control signal that is based on the unit of “frame”. The data of a frame can drive at most 512 lighting circuits, and this is often referred to as 512 DMX channels. Each DMX channel has an available DMX value between 0-255. Such a characteristics feature of DMX allows a user to carry out linear dimming of the lighting circuits through adjusting DMX dimming value, such as the increasingly popular LED lighting facility. A DMX controller is a device that repeatedly transmits DMX control signal to the controlled lighting device. As such, a stage lighting controller person may pre-design and edit a lighting control procedure for each scene, which is pieces of DMX control signal, and store these pieces of control signal in each DMX controller. When the performance starts, the DMX controller corresponding to each scene is activated to allow the lighting device to operate according to the pre-designed schedule. The operation is relatively easy and convenient. Thus, this way of using DMX protocol to assist controlling lighting control for performance stage is now prevailing.

### SUMMARY OF THE INVENTION

An objective of the present invention is to overcome the drawback that the conventional projection device requires a computer, such as a personal computer, or a media servo, to carry out image processing functions, such as image joining, edge fusing, image correction, and special effects, and to provide a projection device that supports DMX protocol and uses DMA signals to control image processing functions of photomosaic of the projection device without requiring a computer, such as personal computer, or media servo, so that the projection device according to the present invention alone can realize the image processing functions of for example image joining, edge fusing, image correction, and special effects, through application of DMX signals and the projection device of the present invention can have excellent coordinated cooperation with digitalized lighting device under the DMX protocol.

Technical features of the present invention are briefed as follows:

The apparatus and system of the present invention comprise a DMX signal receiver processing circuit, an MCU microprocessor circuit, an image processing module, a projection module device, an electromechanical driving circuit, a DMX signal input port, a storage device (such as SD card, CF card, U disc, SATA, but not limited to these storage devices), and a video input port.

Preferably, the DMX signal receiver processing circuit comprises the DMX signal input port.

Preferably, the MCU microprocessor circuit comprises connections with the image processing module, the projection module device, and the electromechanical driving circuit.

Preferably, the image processing module comprises connections with a port for the storage device (such as SD card, CF card, U disc, SATA, but not limited to these storage devices) and the video input port.

Preferably, the video input port is VGA, DVI, HDMI, S-Video, CVBS, and ArtNet.

Preferably, the image processing circuit comprises connection with the projection module device.

An embodiment of the present invention is an apparatus and system for controlling photomosaic of projector with DMX protocol, which use DMX signal to control photomosaic of the projection device so that a plurality of projection devices can be used to simultaneously project images that are joined to form an image of a larger size and can be controlled by the DMX signals to carry out coordinated operation with digitalized lighting device to achieve a unitary performance and control.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram of a system according to the present invention, wherein reference “01” indicates a DMX signal receiver processing circuit, “02” indicates MCU microprocessor circuit, “03” indicates a storage device, “04” indicates an image processing module, “05” indicates a projection module device, and “06” indicates electromechanical driving circuit.

FIG. 2 is a schematic view showing an application of the present invention, in which references “A1”, “A2”, “A3”, and “A4” are projection devices and corresponding projected images.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

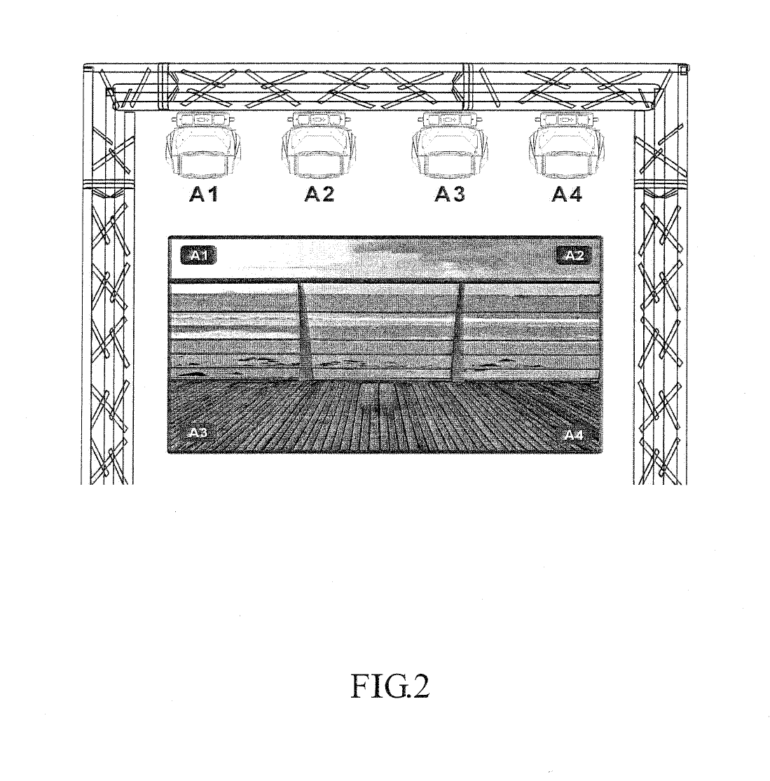

The present invention provides an apparatus and system for controlling photomosaic of projector with DMX protocol, which comprises a DMX signal receiver processing circuit, an MCU microprocessor circuit, an image processing module, a projection module device, an electromechanical driving circuit, a DMX signal input port, a storage device (such as SD card, CF card, U disc, SATA, but not limited to these storage devices), and a video input port. The present invention is characterized in that the DMX signal receiver processing circuit comprises the DMX signal input port. The MCU microprocessor circuit comprises connections with the image processing module, the projection module device, and the electromechanical driving circuit. The image processing module comprises connections with a storage device port and the video input port. The image processing circuit comprises connection with the projection module device. The system comprises standard DMX ports and is compatible to DMX ports of lighting device. DMX signals are used to control the projection device and photomosaic of the projection device so that a plurality of projection devices can be used to simultaneously project images that are joined to form an image of a larger size (see FIG. 2) and can be controlled by the DMX signals to carry out coordinated operation with digitalized lighting device to achieve a unitary performance and control. With the use of DMX signal, it is possible to carry out, through the image processing module, various image processing effects, such as image trimming, shape adjusting (planar surface correction and adjustment, curved surface correction and adjustment), edge fusing, color adjusting, multiple layer mixing, transparency adjusting, and special displaying (rotating, kaleidoscope, stretching), and it is also possible to control the electromechanical driving function of the projection device (such as the functions of horizontal, vertical, focusing, reduction/expansion, and light shielding).

The present invention provides a technique that uses DMX protocol to control photomosaic of projector and more specifically, a system that controls a plurality of projector devices to realize photomosaic with DMX protocol. The present invention comprises image processing, projection module device, electromechanical driving circuit, video input (which can be input of VGA, DVI, HDMI, S-Video, CVBS, and ArtNet port), storage device (such as CF card, SD card, and externally connected USB storage device) that stores therein image or video files, MCU microprocessor circuit, and DMX signal receiver processing circuit. The apparatus of the present invention supports DMX protocol and uses DMX signals to perform control so as to allow a plurality of projection devices to show perfect seam-free joined image without using a computer, such as personal computer, or a media servo, and can be controlled by DMX for coordinated operation with digitalized lighting devices.

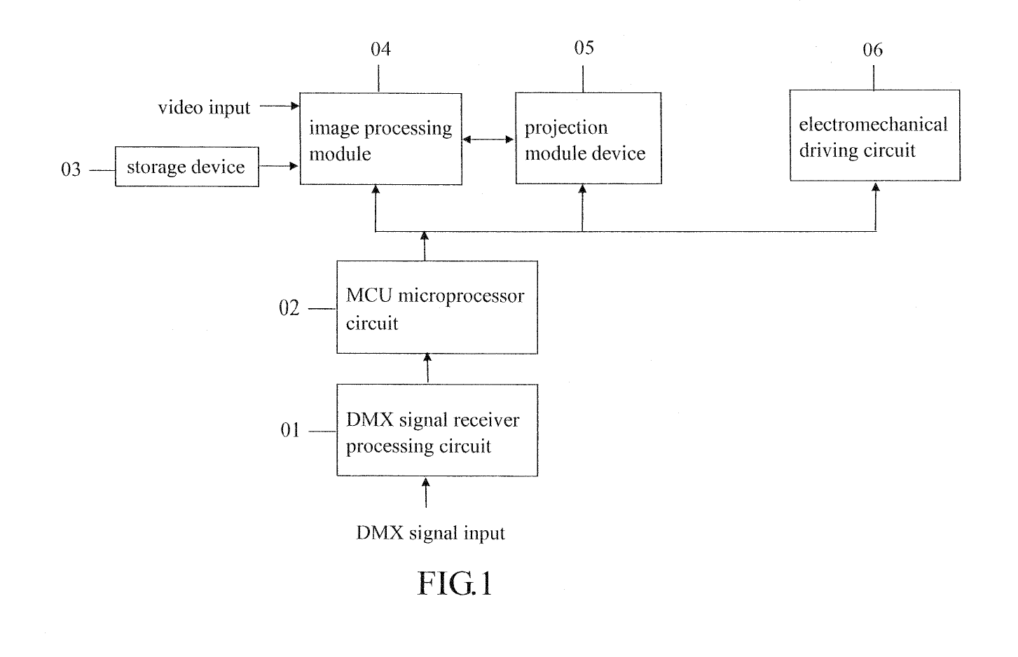

As shown in FIG. 1, the present invention provides an apparatus and system for controlling photomosaic of projector with DMX protocol, which comprises a DMX signal receiver processing circuit, an MCU microprocessor circuit, an image processing module, a projection module device, an electromechanical driving circuit, a DMX signal input port, a storage device (such as SD card, CF card, U disc, SATA, but not limited to these storage devices), and a video input port.

The DMX signal receiver circuit is connected to the MCU microprocessor circuit. DMX signals are input through the DMX signal input port and are transmitted through the DMX signal receiver circuit to the MCU microprocessor circuit.

The MCU microprocessor circuit is connected to the image processing module, the projection module device, and the electromechanical driving circuit. Different DMX signals are processed by the MCU microprocessor circuit and can select image or video files built in the storage device, or external video input to the image processing module so that it is possible to carry out various image processing by controlling the image processing module and no computer, such as personal computer, or media servo is needed.

The projection module device is connected to the image processing module so that when the projection module device reads displaying information from the image processing module, the image processing module reads corresponding displaying information from the storage device or the video input. The image processing module is connected to the storage device.

Through different DMX signals, it is possible to control the electromechanical circuit to realize switching among operations of horizontal, vertical, focusing, reduction/expansion, and light shielding of the projection devices, but not limited to these functions.

As such, a stage lighting controller person or a user may perform perfect seam-free image joining and image processing by only using a plurality of projection devices with the aid of using the technique of DMX signal, and no computer, such as personal computer, or media servo is needed. It is also possible to have coordinated operation between the projection devices and digitalized lighting devices under the control of DMX signals so as to realize unitary performance and control. Such a method of unitary and concentrated control realized through using DMX signal can greatly lower down the strength and skill requirement of the stage operation persons.

The above discussed embodiments are not to impose limitation to the present invention and those technical solutions having the same structure as the present invention are considered within the scope of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An apparatus and system for controlling photomosaic of projector with DMX protocol comprising a DMX signal receiver processing circuit, an MCU microprocessor circuit, an image processing module, a projection module device, an electromechanical driving circuit, a DMX signal input port, a storage device, and a video input port, and characterized in that the DMX signal receiver processing circuit comprises a DMX signal input port, the MCU microprocessor circuit comprises connections with the image processing module, the projection module device, and the electromechanical driving circuit, the image processing module comprises connections with a storage device port and the video input port, and the image processing module comprises connection with the projection module device.

2. The apparatus and system for controlling photomosaic of projector with DMX protocol according to claim 1, characterized in that the system comprises standard DMX ports and is compatible to DMX ports of lighting device.

3. The apparatus and system for controlling photomosaic of projector with DMX protocol according to claim 1, characterized in that DMX signals are used to control photomosaic of the projection device so that a plurality of projection devices can be used to simultaneously project images that are joined to form an image of a larger size, without using a computer or a media servo, to thereby realize perfect image joining.

4. The apparatus and system for controlling photomosaic of projector with DMX protocol according to claim 1, characterized in that through the user of DMX signal, the image processing module is controlled to carry out image processing, such as image trimming, shape adjusting (planar surface correction and adjustment, curved surface correction and adjustment), edge fusing, color adjusting, multiple layer mixing, transparency adjusting, and special displaying (rotating, kaleidoscope, stretching).

5. The apparatus and system for controlling photomosaic of projector with DMX protocol according to claim 1, characterized in that the image processing module is connected to the storage device or the video input and the image processing module directly reads image or video files built in the storage device.
